(19) United States
(12) Patent Application Publication
(10) Pub. No.: US 2023/0147648 A1
(43) Pub. Date: May 11, 2023

(54) VOLTAGE VARIABLE BATTERY CELL MODULE AND SERIES OUTPUT CONNECTOR THEREOF

(71) Applicant: AMITA TECHNOLOGIES INC., Taoyuan City (TW)

(72) Inventors: Chueh-Yu KO, Taoyuan City (TW); Hou-Chi CHEN, Taoyuan City (TW); Chia-Wen YEN, Taoyuan City (TW); Ming-Hsiao TSAI, Taoyuan City (TW)

(21) Appl. No.: 17/698,881

(22) Filed: Mar. 18, 2022

(30) Foreign Application Priority Data
Nov. 9, 2021 (TW) 110141688

(51) Int. Cl. H01M 50/51; H01M 50/512; H01M 50/543

(52) U.S. Cl. CPC H01M 50/51; H01M 50/512; H01M 50/543

(57) ABSTRACT

This disclosure provides a voltage variable battery cell module having two battery cell groups and an insulative seat. An output anode and an output cathode are embedded in the insulative seat. The battery cell groups are respectively electrically connected to the output anode and the output cathode, and the battery cell groups are connected in series.

### BACKGROUND OF THE DISCLOSURE

### Technical Field

The technical field of the present disclosure relates to a voltage variable battery cell module, and in particular, to a voltage variable battery cell module.

### Description of Related Art

The related-art battery cell modules are often constructed by a plurality of battery cells arranged to stack onto each other, and the related-art battery cell typically includes a positive electrode and a negative electrode, and the battery cells are connected in parallel, followed by connecting to the control circuit board via the positive and negative electrodes. The voltage of the battery cell depends on the potential difference between the materials of the positive electrode plate and the negative electrode plate. Since the materials available for the selection of positive electrode and negative electrode are limited, the voltage of a battery cell is generally at approximately 3.7 V. Accordingly, as the voltage of a lithium battery is limited by the material, the increased number of battery cells only increase the electric capacity but the voltage remains unchanged. Consequently, to satisfy different voltage requirements of various devices, it is necessary to utilize transformation circuits for voltage conversion.

In view of the above, the inventor seeks to overcome the aforementioned drawbacks associated with the current technology and aims to provide an effective solution through extensive researches along with utilization of academic principles and knowledge.

### SUMMARY OF THE DISCLOSURE

The present disclosure provides a voltage variable battery cell module, including two battery cell groups and an insulative seat. The insulative seat includes an output anode and an output cathode. In addition, the battery cell groups are electrically connected to the output anode and the output cathode respectively, and the battery cells are connected in series with each other.

According to the voltage variable battery cell module of present disclosure, at least one of the battery cell groups includes a plurality of battery cells connected in parallel with each other. At least one of the battery cell groups may include a plurality of battery cells connected in parallel with each other.

According to the voltage variable battery cell module of present disclosure, it further includes a series electrode; the series electrode is respectively connected to each one of the battery cell groups to connect the battery cell groups in series. The series electrode is of an elongated shape and extended to cross between the output anode and the output cathode.

According to the voltage variable battery cell module of present disclosure, the series electrode is of an elongated shape; the series electrode has a non-uniform cross-sectional area, and a narrowest portion of the series electrode forms a buffer section.

According to the voltage variable battery cell module of present disclosure, the series electrode includes a detection terminal. The detection terminal protrudes out of the insulative seat. The output anode, the output cathode and the detection terminal protrude out of the insulative seat at the same side.

According to the voltage variable battery cell module of present disclosure, it further includes an outer casing; the outer casing includes an opening; the battery cell groups are received inside the outer casing and the insulative seat is arranged on the opening to close the outer casing.

The present disclosure further provides a series output connector, including an insulative seat. The insulative seat has an output anode, an output cathode and a series electrode embedded therein. The series electrode has an elongated shape and is extended to cross between the output anode and the output cathode.

According to the series output connector of the present disclosure, the series electrode is extended to cross two sides of the output anode. The series electrode is extended to cross two sides of the output cathode.

According to the series output connector of the present disclosure, the series electrode includes a detection terminal. The detection terminal protrudes out of the insulative seat. The output anode, the output cathode and the detection terminal protrude out of the insulative seat at the same side.

According to the series output connector of the present disclosure, the series electrode has a non-uniform cross-sectional area, and a narrowest portion of the series electrode forms a buffer section.

In view of the above, the voltage variable battery cell module of the present disclosure is able to utilize the multiplied voltage resulting from the internal battery cells connected in series to change the output voltage depending upon the use requirements of different devices.

### BRIEF DESCRIPTION OF THE DRAWINGS

FIG. 1 is an exploded view of the series output connector of the voltage variable battery cell module according to the first exemplary embodiment of the present disclosure;

FIG. 2 is a perspective exploded view of the voltage variable battery cell module according to the first exemplary embodiment of the present disclosure;

FIG. 3 is a schematic view showing the battery cells connected in series in the voltage variable battery cell module according to the first exemplary embodiment of the present disclosure;

FIG. 4 is a cross-sectional view of the voltage variable battery cell module according to the first exemplary embodiment of the present disclosure;

FIG. 5 is another cross-sectional view of the voltage variable battery cell module according to the first exemplary embodiment of the present disclosure;

FIG. 6 is an exploded view of the series output connector of the voltage variable battery cell module according to the second exemplary embodiment of the present disclosure;

FIG. 7 is a perspective exploded view of the voltage variable battery cell module according to the second exemplary embodiment of the present disclosure;

FIG. 8 is a schematic view showing the battery cells connected in series in the voltage variable battery cell module according to the second exemplary embodiment of the present disclosure;

FIG. 9 is a cross-sectional view of the voltage variable battery cell module according to the second exemplary embodiment of the present disclosure; and

FIG. 10 is another cross-sectional view of the voltage variable battery cell module according to the second exemplary embodiment of the present disclosure.

### DETAILED DESCRIPTION

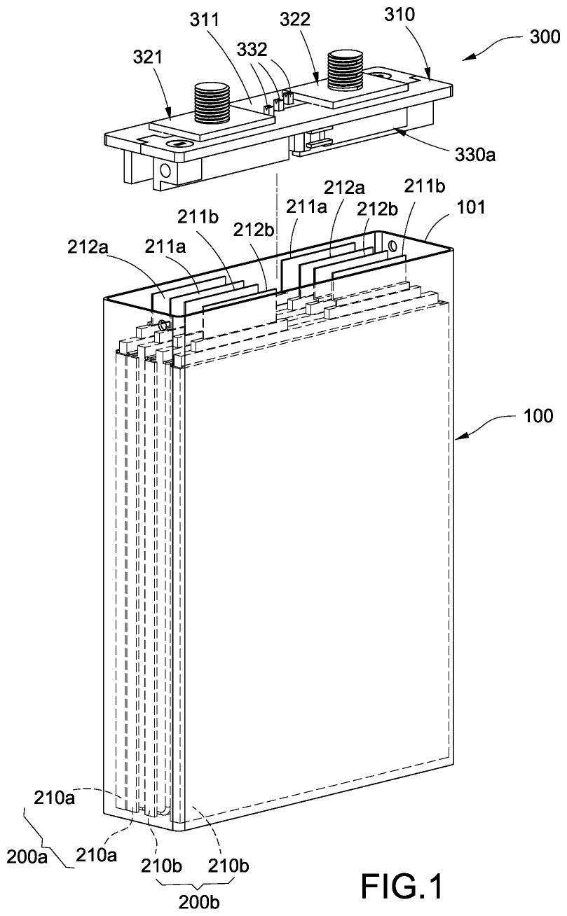

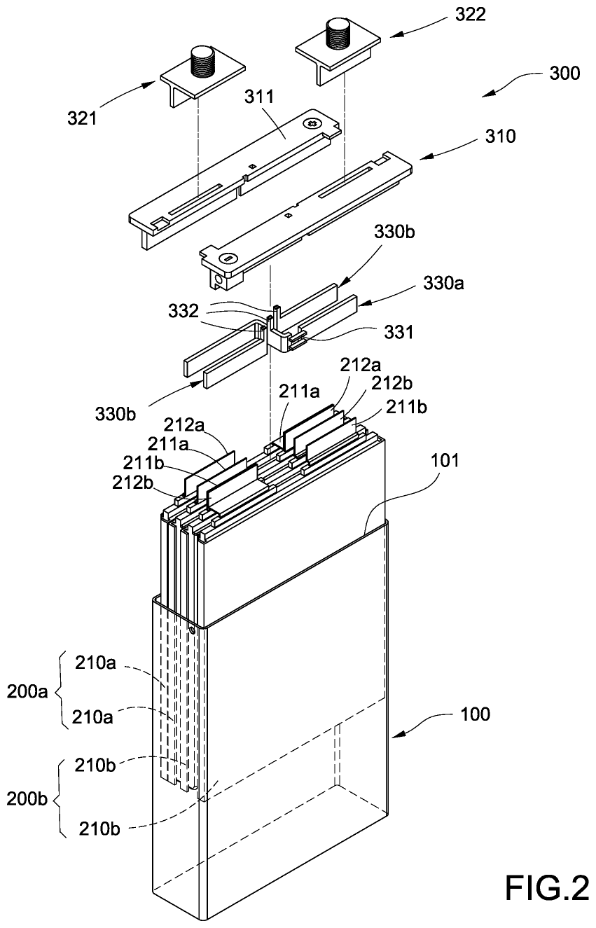

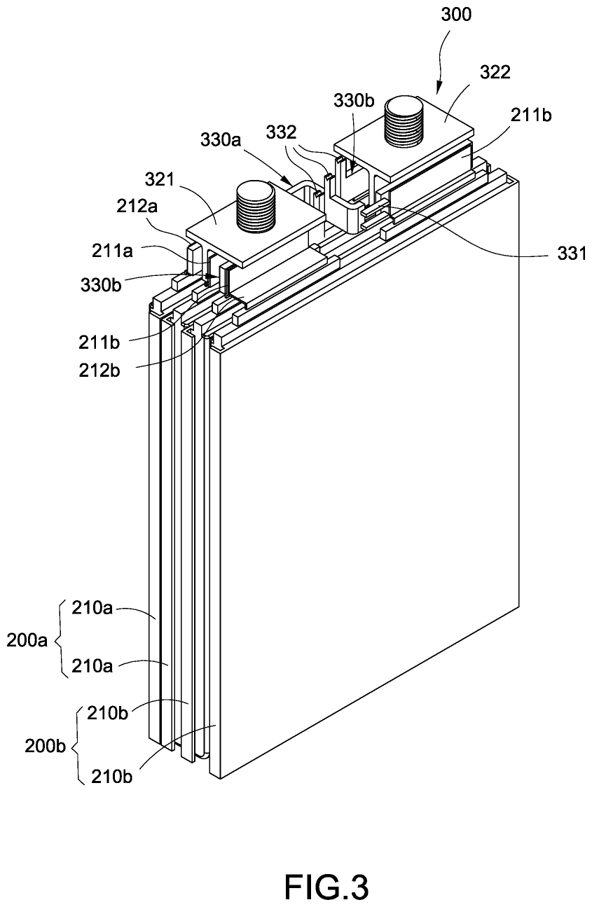

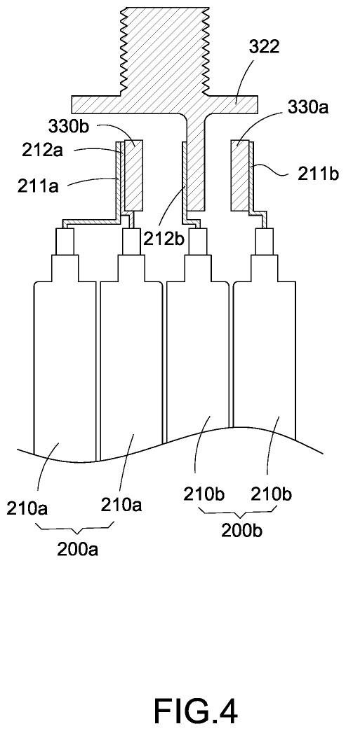

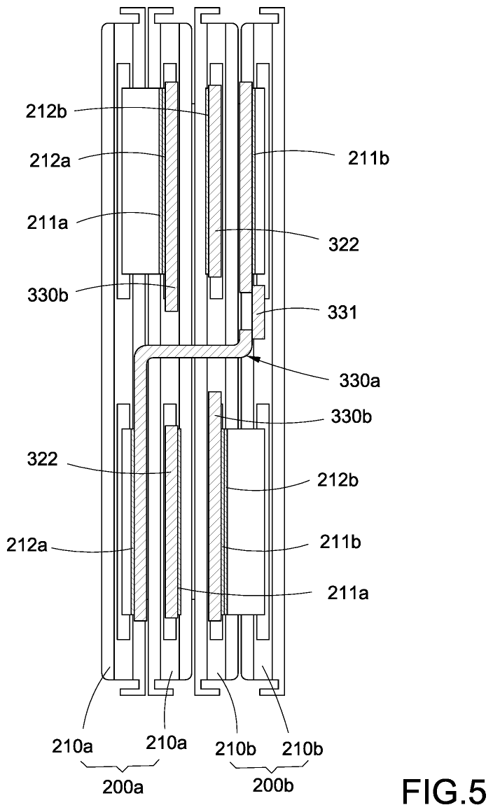

Please refer to FIG. 1 to FIG. 5. According to a first exemplary embodiment of the present disclosure, a voltage variable battery cell module includes an outer casing 100, at least two battery cell groups 200a, 200b and a series output connector 300.

In this exemplary embodiment, the outer casing 100 is a flat insulation box, and one lateral side of the outer casing 100 includes an opening 101.

The battery cell groups 200a, 200b are stacked and received inside the outer casing 100. In this exemplary embodiment, each one of the battery cell groups 200a, 200b respectively includes a plurality of battery cells 210a, 210b connected in series with each other. To be more specific, each one of the battery cells 210a, 210b respectively includes a packaging bag, and the packaging bag includes anode plates and cathode plates stacked in layers therein. One of the anode plates includes one anode lug 211a, 211b extended outward, and one of the cathode plates includes one cathode lug 212a, 212b extended outward. The anode lugs 211a, 211b and the cathode lugs 212a, 212b protrude out of the packaging bag, and the anode lugs 211a, 211b and cathode lugs 212a, 212b are disposed at two sides of the opening 101 for electrical connection. A plurality of battery cell groups 200a, 200b are connected to a control circuit board and are further packaged to form a battery.

A series output connector 300 is provided to be electrically connected to each one of the battery cell groups 200a, 200b for external electrical connection thereto, and the series output connector 300 may be connected to the battery cell groups 200a, 200b in series. In this exemplary embodiment, the series output connector 300 includes an insulative seat 310. The insulative seat 300 includes an outer side surface 311, and the insulative seat 310 is arranged on the opening 101 to close the outer casing 100 and the outer side surface 311 is exposed externally. The insulative seat 310 includes an output anode 321 and an output cathode 322. In addition, at least a portion of each of the output anode 321 and the output cathode 322 is exposed at the outer side surface 311 of the insulative seat 310 for external electrical connection thereto. Each one of the battery cell groups 200a, 200b is electrically connected to the output anode 321 and the output cathode 322 respectively, and the battery cell groups 200, 200b are connected in series with each other. To be more specific, the insulative seat 310 includes at least one series electrode 330a, 330b embedded therein. The series electrodes 330a, 330b are connected to each one of the battery cell groups 200a, 200b respectively to connect the battery cell groups 200a, 200b in series. In this exemplary embodiment, the insulative seat 310 is formed by a plurality of component parts to facilitate the assembly of the output anode 321, the output cathode 322 and the series electrode 330a, 330b. The present disclosure is not limited to such configuration only.

The specific structure of the series electrodes 330a, 330b is described in details as follows. In this exemplary embodiment, it includes three series electrodes 330a, 300b, and each one of the series electrodes 330a, 330b are of an elongated shape. The series electrodes 330a, 330b are used for connecting the anode lugs 211a, 211b and the cathode lugs 212a, 212b of any two battery cells 210a, 210b to connect the two battery cells 210a, 210b in series. Two ends of at least one of the series electrodes 330a are arranged corresponding to the output anode 321 and the output cathode 322 to cross between the output anode 321 and the output cathode 322. In addition, the series electrode 330a is extended in an S shape such that it is able to cross the two sides of the output cathode 322 respectively. The series electrode 330a is extended to cross the two sides of the output cathode 322 to connect the anode lug 211 and the cathode lug 212a, 212b disposed at two sides of the opening 101 respectively. In this exemplary embodiment, the other two series electrodes 330a are in a straight-line shape and are connected to the anode lugs 211a, 211b and the cathode lugs 212a, 212b arranged parallel to each other at the same side of the opening 101.

In this exemplary embodiment, the series electrode 330b includes a buffer section 331 arranged thereon and used as a fuse protection mechanism for current overflow. To be more specific, the series electrode 330a has a non-uniform cross-sectional area, and a narrowest portion of the series electrode 330a forms the buffer section 331. During the operation of the series electrode 330a, current flows from one end of the series electrode 330a to another end of the series electrode 330a. The resistance of the buffer section 331 is greater than other parts of the series electrode 330a. As the current load increases, the temperature increasing rate of the buffer section 331 is higher than that of the rest of the parts of the series electrode 330a. When the current overflow occurs at the series electrode 330a, the buffer section 331 may reach the melting point first such that fusing occurs. In comparison to the related-art fusing type of fuse that uses metal bridge of low melting point to achieve the fusing mechanism, the fusing mechanism of this disclosure facilitates the manufacturing process and is able to prevent external resistance from presenting at the connection part of different metals.

In this exemplary embodiment, the series electrodes 330a, 330b may include one detection terminal 332. The detection terminal 332 protrudes out of the insulative seat 310. The output anode 321, the output cathode 322 and the detection terminal 332 protrude out of the insulative seat 310 at the same side. The detection terminal 332 is used to detect whether the battery working state is normal. The voltage difference between the detection terminal 332 and the output anode 321 or output cathode 322 may be obtained for comparison with the predefined value to determine whether the battery working state is normal. In case of voltage abnormality, it may be compensated and corrected with the control circuit.

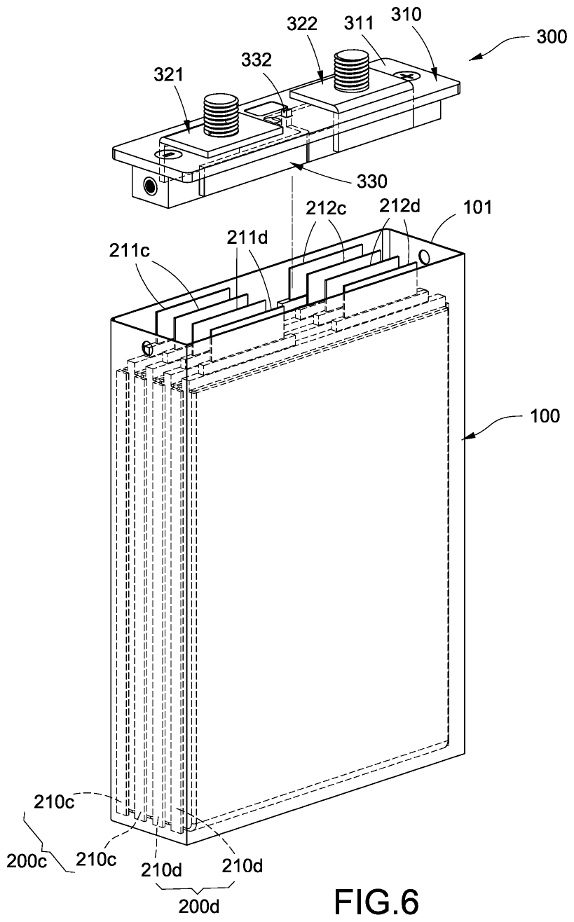

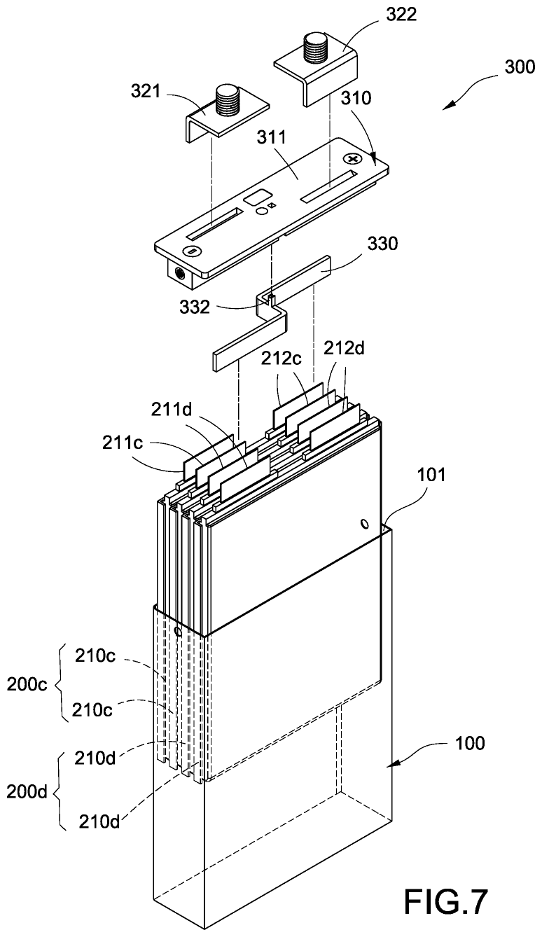

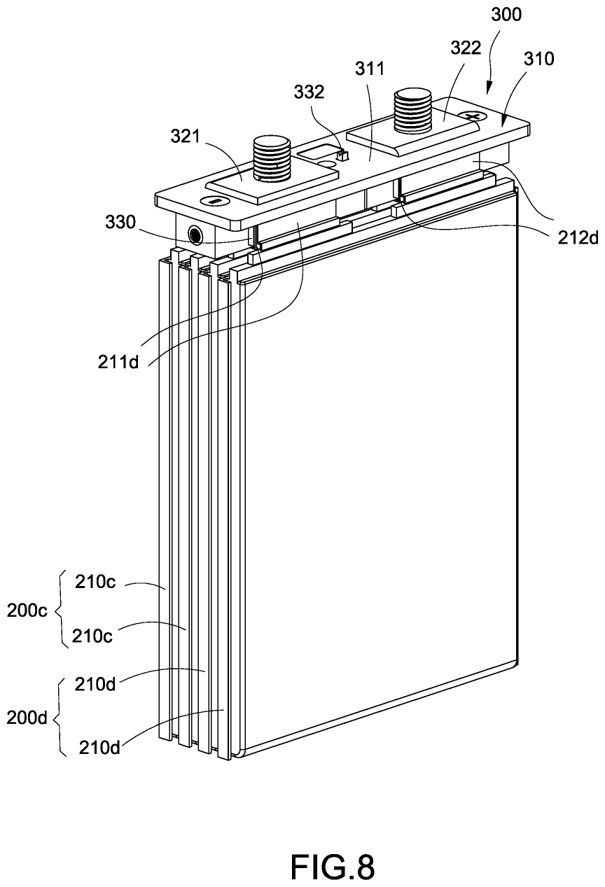

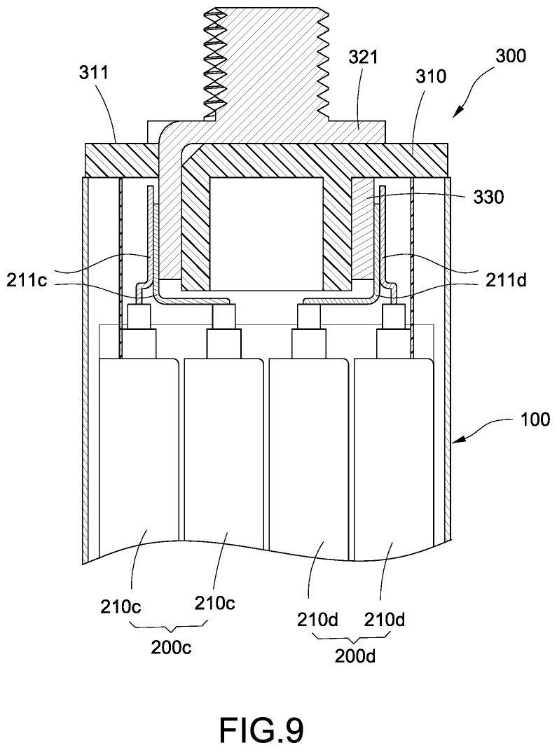

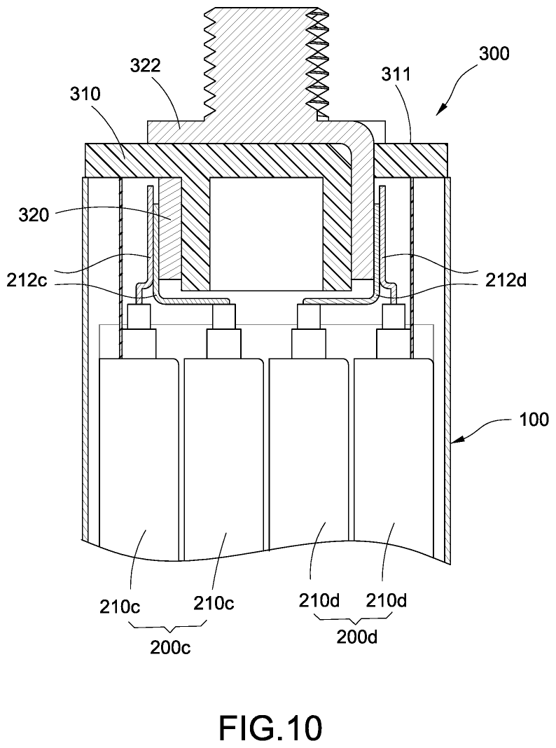

Please refer to FIG. 6 to FIG. 10. According to a second exemplary embodiment of the present disclosure, a voltage variable battery cell module includes an outer casing 100, at least two battery cell groups 200c, 200d and a series output connector 300.

In this exemplary embodiment, the outer casing 100 is a flat insulation box, and one lateral side of the outer casing 100 includes an opening 101.

The battery cell groups 200c, 200d are stacked and received inside the outer casing 100. In this exemplary embodiment, each one of the battery cell groups 200c, 200d respectively includes a plurality of battery cells 210c, 210d connected in series with each other. To be more specific, each one of the battery cells 210c, 210d respectively includes a packaging bag, and the packaging bag includes anode plates and cathode plates stacked in layers therein. One of the anode plates includes one anode lug 211c, 211d extended outward, and one of the cathode plates includes one cathode lug 212c, 212d extended outward. The anode lugs 211c, 211d and the cathode lugs 212c, 212d protrude out of the packaging bag, and the anode lugs 211c, 211d and cathode lugs 212c, 212d are disposed at two sides of the opening 101 for electrical connection. A plurality of battery cell groups 200c, 200d are connected to a control circuit board and are further packaged to form a battery.

A series output connector 300 is provided to be electrically connected to each one of the battery cell groups 200c, 200d for external electrical connection thereto, and the series output connector 300 may connect the battery cell groups 200c, 200d in series. In this exemplary embodiment, the series output connector 300 includes an insulative seat 310. The insulative seat 300 includes an outer side surface 311, and the insulative seat 310 is arranged on the opening 101 to close the outer casing 100 and the outer side surface 311 is exposed externally. The insulative seat includes an output anode 321 and an output cathode 322. In addition, at least a portion of each of the output anode 321 and the output cathode 322 is exposed at the outer side surface 311 of the insulative seat 310 for external electrical connection thereto. Each one of the battery cell groups 220c, 200d is electrically connected to the output anode 321 and the output cathode 322 respectively, and the battery cells 200c, 200d are connected in series with each other. To be more specific, the insulative seat 310 includes a series electrode 330 embedded therein. The series electrodes 330 is connected to each one of the battery cell groups 200c, 200d respectively to connect the battery cell groups 200c, 200d in series.

The specific structure of the series electrode 330 is described in the following. In this exemplary embodiment, it includes a series electrode 330, and the series electrode 330 is of an elongated shape and used for connecting to the anode lugs 211c, 211d and cathode lugs 212c, 212d of any two battery cells 210c, 210d to connect the two battery cells 210c, 210d in series. Two ends of the series electrodes 330 are arranged corresponding to the output anode 321 and the output cathode 322 to cross between the output anode 321 and the output cathode 322. In addition, such series electrode 330 is extended in an S shape to cross the two sides of the output cathode 322 respectively. The series electrode 330 is extended to cross the two sides of the output cathode 322 to connect the anode lugs 211c, 211d and the cathode lugs 212c, 212d disposed at two sides of the opening 101 respectively.

In this exemplary embodiment, the series electrode 330 may include a detection terminal 332. The detection terminal 332 protrudes out of the insulative seat 310. The output anode 321, the output cathode 322 and the detection terminal 322 protrude out of the insulative seat 310 at the same side. The detection terminal 322 is used to detect whether the battery working state is normal. The voltage difference between the detection terminal 332 and the output anode 321 or output cathode 322 may be obtained for comparison with the predefined value to determine whether the battery working state is normal. In case of voltage abnormality, it may be compensated and corrected with the control circuit.

In view of the above, the voltage variable battery cell module of the present disclosure is able to utilize the multiplied voltage resulting from the internal battery cells 210a, 210b, 210c, 210d connected in series to change the output voltage depending upon the use requirements of different devices.

The above description is provided to illustrate the exemplary embodiments of the present disclosure only such that it shall not be treated as limitation to the claimed scope of the present disclosure. In addition, any equivalent modification made based on the present disclosure shall be considered to be within the claimed scope of the present disclosure.

What is claimed is:

1. A voltage variable battery cell module, comprising:
two battery cell groups and an insulative seat, the insulative seat comprising an output anode and an output cathode embedded therein;
wherein the battery cell groups are electrically connected to the output anode and the output anode respectively, and the battery cell groups are connected in series with each other.

2. The voltage variable battery cell module according to claim 1, wherein at least one of the battery cell groups comprises a plurality of battery cells connected in parallel with each other.

3. The voltage variable battery cell module according to claim 1, wherein at least one of the battery cell groups comprises a plurality of battery cells connected in series with each other.

4. The voltage variable battery cell module according to claim 1, further comprising a series electrode, wherein the series electrode is respectively connected to each one of the battery cell groups to connect the battery cell groups in series.

5. The voltage variable battery cell module according to claim 4, wherein the series electrode is of an elongated shape and extended to cross between the output anode and the output cathode.

6. The voltage variable battery cell module according to claim 4, wherein the series electrode is of an elongated shape, the series electrode comprises a non-uniform cross-sectional area, and a buffer section is disposed on a narrowest portion of the series electrode.

7. The voltage variable battery cell module according to claim 4, wherein the series electrode comprises a detection terminal disposed thereon.

8. The voltage variable battery cell module according to claim 7, wherein the detection terminal protrudes out of the insulative seat.

9. The voltage variable battery cell module according to claim 8, wherein the output anode, the output cathode and the detection terminal protrude out of the insulative seat at a same side.

10. The voltage variable battery cell module according to claim 1, further comprising an outer casing, wherein the outer casing comprises an opening, the battery cell groups are received inside the outer casing and the insulative seat is arranged on the opening to close the outer casing.

11. A series output connector, comprising:
an insulative seat, comprising an output anode, an output cathode and a series electrode embedded therein;
wherein the series electrode comprises an elongated shape and is extended to cross between the output anode and the output cathode.

12. The series output connector according to claim 11, wherein the series electrode is extended to cross two sides of the output anode.

13. The series output connector according to claim 11, wherein the series electrode is extended to cross two sides of the output cathode.

14. The series output connector according to claim 11, wherein the series electrode comprises a detection terminal disposed thereon.

15. The series output connector according to claim 14, wherein the detection terminal protrudes out of the insulative seat.

16. The series output connector according to claim 15, wherein the output anode, the output cathode and the detection terminal protrude out of the insulative seat at a same side.

17. The series output connector according to claim 11, wherein the series electrode comprises a non-uniform cross-sectional area, and a buffer section is disposed on a narrowest portion of the series electrode.
